(19) United States
(12) Patent Application Publication
(10) Pub. No.: US 2024/0209685 A1
(43) Pub. Date: Jun. 27, 2024

(54) VENETIAN BLIND CAPABLE OF PERFORMING AUTOMATIC ALIGNMENT FOR SLATS

(71) Applicant: UNION WINNER INTERNATIONAL CO., LTD., TAIPEI CITY (TW)

(72) Inventor: Ming-Tsung PAI, CAOTUN TOWNSHIP (TW)

(73) Assignee: UNION WINNER INTERNATIONAL CO., LTD., TAIPEI CITY (TW)

(21) Appl. No.: 18/599,468

(22) Filed: Mar. 8, 2024

Related U.S. Application Data
(63) Continuation-in-part of application No. 18/336,628, filed on Jun. 16, 2023.
Application No. 18/336,628 is a continuation-in-part of application No. 16/589,628, filed on Oct. 1, 2019, now Pat. No. 11,873,681.

(51) Int. Cl. E06B 9/384; E06B 9/303

(52) U.S. Cl. CPC E06B 9/384; E06B 9/303

(57) ABSTRACT

A venetian blind includes a headrail, a bottom rail, a first pull cord, and a second pull cord. Two ladder cords are provided between the headrail and the bottom rail. The ladder cords each have a first warp, a second warp, a plurality of wefts connected with the first and second wefts and supporting slats, and a plurality of first loops connected with the first warp. The slats each have a perforation passing through the top and bottom surfaces of the slat and penetrated by the first loop, and a recess provided at one of the inner and outer edges of the slat. At least one of the first pull cord, the second pull cord, the first warp, and the second warp is positioned in the recesses of the slats. As such, the venetian blind of the prevent invention can achieve an effect of automatic alignment of the slats.

### BACKGROUND OF THE INVENTION

### 1. Field of the Invention

The present invention relates to venetian blinds and more particularly, to a venetian blind that can achieve an effect of automatic alignment of the slats.

### 2. Description of the Related Art

As far as a traditional venetian blind is concerned, the slats can be driven by the ladder cords to be in a tilted state after unfolded, thereby providing a light-blocking effect. However, the ladder cords only provide support to the slats and does not have the function of restricting transvers displacement of the slats. Therefore, as long as the ladder cords or the slats are swung to a large extent due to an external force, or when uneven force is applied during the folding or unfolding of the slats, it may result in uneven alignment of the two ends of the slats. This causes a cluttered appearance.

### SUMMARY OF THE INVENTION

It is a primary objective of the present invention to provide a venetian blind that can achieve an effect of automatic alignment of slats.

To attain the above objective, the venetian blind of the present invention comprises a headrail, a bottom rail, two ladder cords, and a lifting unit. The bottom rail is located below the headrail. The slats are provided between the headrail and the bottom rail. The slats each have a top surface, a bottom surface, a first edge connected with the top and bottom surfaces, a second edge connected with the top and bottom surfaces and opposite to the first edge, a perforation passing through the top and bottom surfaces, and a recess provided at one of the first and second edges. The ladder cords are provided between the headrail and the bottom rail. The ladder cords each have a first warp adjacent to the first edges of the slats, a second warp adjacent to the second edges of the slats, a plurality of wefts connected with the first and second warps and supporting the bottom surfaces of the slats, and a plurality of first loops connected with the first warp and penetrated in the perforations of the slats. The lifting unit has a first pull cord adjacent to the first wrap and a second pull cord adjacent to the second wrap. At least one of the first pull cord, the second pull cord, the first warp, and the second warp is positioned in the recesses of the slats.

It can be seen from the above that the venetian blind of the present invention uses the first loops to be inserted into the perforations, so that the slats are prevented from excessive transverse displacement, and further, the venetian blind of the present invention uses the recesses to accommodate at least one of the first pull cord, the second cord, the first warp, and the second warp, thereby allowing the slats to achieve an automatic alignment effect.

Preferably, the recess is provided at the first edge. When the slats are in a horizontal state, the first pull cord and/or the first warp is positioned in the recesses of the slats.

Preferably, the recess is provided at the second edge. When the slats are in a horizontal state, the second pull cord and/or the second warp is positioned in the recesses of the slats.

Preferably, the recess and the perforation are provided at the first edge. The slats each have a slot provide with one end thereof forming an opening at the first edge and the other end thereof communicating with the perforation. The first loop is inserted in the slot through the opening and penetrated in the perforation along the slot. The recess and the slot are located at two opposite sides of the perforation.

Preferably, the first pull cord passes through the first loops. Through the mutual restraint of the first pull cord and the first loops, the slats can more accurately achieve the automatic alignment effect.

Preferably, the first loops each have a first end portion provided with one end thereof connected with first warp, a second end portion provided with one end thereof connected with first warp, and a penetration segment connected with the first and second end portions and penetrated in the perforation. A junction of the first end portion and the first warp is spaced from a junction of the second end portion and the first warp.

Preferably, the first loops each have two penetration segments penetrated in the perforation and each provided with one end thereof connected with the first warp, and a loop portion connected with the other ends of the penetration segments and penetrated by the first pull cord. A junction of one of the penetration segments and the first warp is spaced from a junction of the other of the penetration segments and the first warp.

Preferably, the first and second pull cords are located at the left and right sides of the wefts.

Preferably, at least one of the first and second pull cords is wound around the wefts in a left-right manner.

Preferably, the ladder cords each further have a plurality of second loops connected with the second wefts for penetration of the second pull cord.

Other advantages and features of the present invention will be fully understood by reference to the following specification in conjunction with the accompanying drawings, in which like reference signs denote like components of structure.

### BRIEF DESCRIPTION OF THE DRAWINGS

FIG. 1 is a perspective view of a venetian blind of a first embodiment of the present invention, showing that the slats are in a horizontal state.

FIG. 2 is a perspective view of a venetian blind of a first embodiment of the present invention from another perspective, showing that the slats are in a horizontal state.

FIG. 3 is an enlarged view of part A of FIG. 2.

FIG. 4 is a perspective view of a part of a slat provided by the venetian blind of the first embodiment of the present invention.

FIG. 5 is a partially top view of the venetian blind of the first embodiment of the present invention.

FIG. 6 is a partially sectional view of the venetian blind of the first embodiment of the present invention.

FIG. 7 is a perspective view of the venetian blind of the first embodiment of the present invention, showing that the slats are in a tilted state.

FIG. 8 is an enlarged view of part A of FIG. 7.

FIG. 9 is a partially enlarged view of the venetian blind of a second embodiment of the present invention.

FIG. 10 is a partially enlarged view of the venetian blind of the second embodiment of the present invention from another perspective.

FIG. 11 is a perspective view of the venetian blind of a third embodiment of the present invention, showing that the slats are in a horizontal state.

FIG. 12 is an enlarged view of part A of FIG. 11.

FIG. 13 is an enlarged view of part B of FIG. 11.

FIG. 14 is a perspective view of the venetian blind of a fourth embodiment of the present invention.

FIG. 15 is an enlarged view of part A of FIG. 14.

FIG. 16 is an enlarged view of part B of FIG. 14.

FIG. 17 is a perspective view of the venetian blind of a fifth embodiment of the present invention.

### DETAILED DESCRIPTION OF THE INVENTION

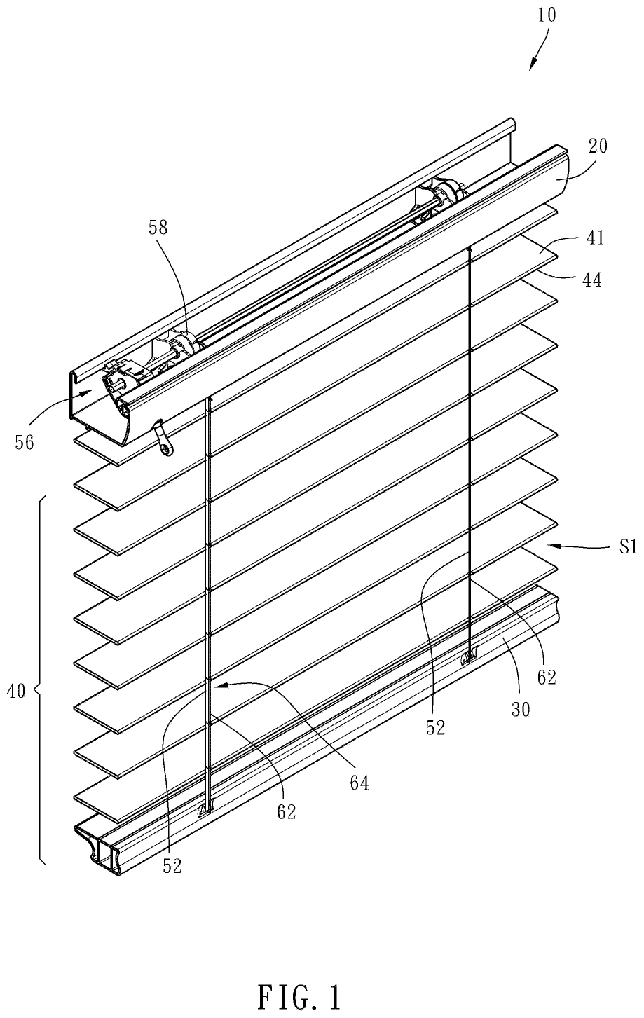

Referring to FIGS. 1, 2, and 6, a venetian blind 10 of a first embodiment of the present invention comprises a headrail rail 20, a bottom rail 30, a plurality of slats 40, two ladder cords 50, and a lifting unit 60.

The headrail 20 and the bottom rail 30 are arranged in an up-down manner.

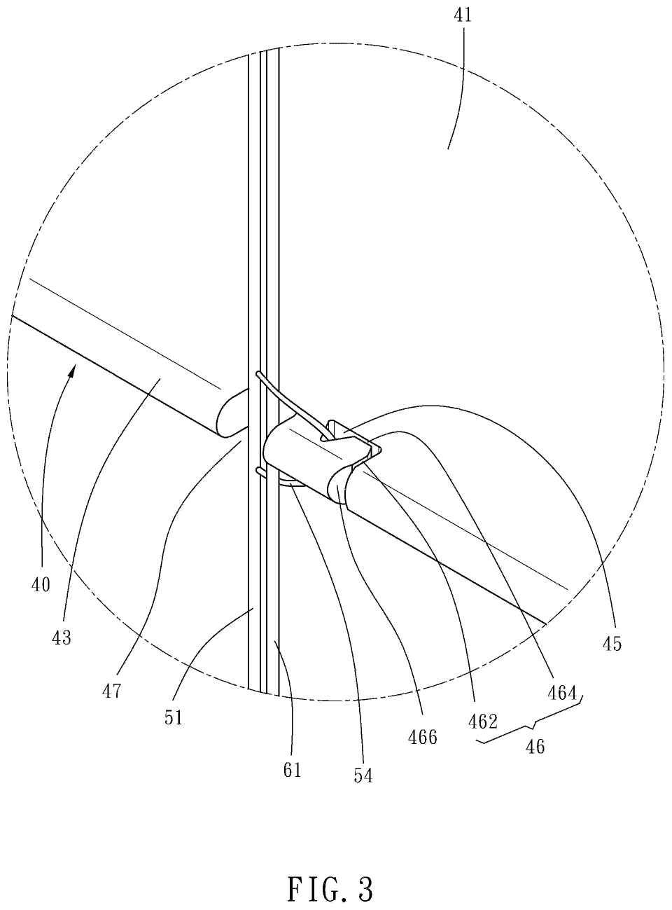

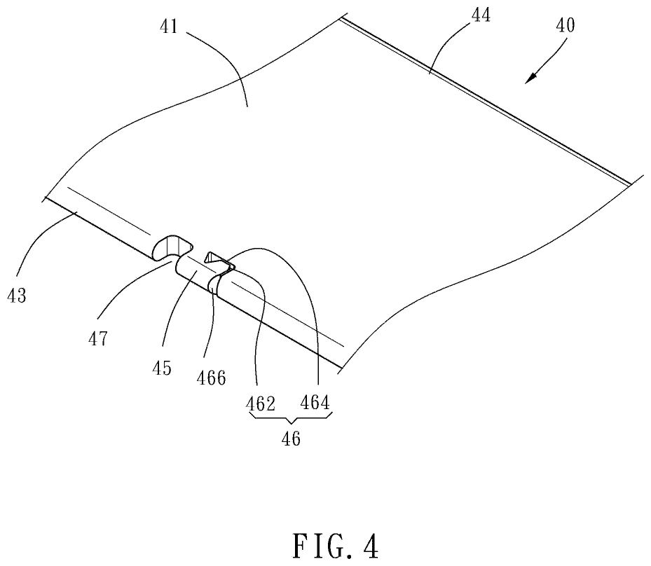

The slats 40 are provided between the headrail 20 and the bottom rail 30. As shown in FIGS. 3 to 6, the slats 40 each have a top surface 41, a bottom surface 42, a first edge 43 (the first edge 43 referred to here is the edge facing the outdoors) connected with the top and bottom surfaces 41, 42, a second edge 44 (the second edge 44 referred to here is the edge facing the indoors) connected with the top and bottom surface 41, 42 and opposite to the first edge 43. In this embodiment, two ends of each of the slats 40 each have a perforation 45, a slot 46, and a recess 47. The perforation 45, the slot 46, and the recess 47 are provided at the first edge 43, wherein the perforation 45 and the slot 46 pass through the top and bottom surfaces 41, 42. In this embodiment, the perforation 45 is triangular, so that the peripheral wall of the perforation 45 has two guiding surfaces 452. The distance between the two guiding surfaces 452 gradually decrease towards the first edge 43, so that a positioning portion 454 is formed at a junction of the two guiding surfaces 452. The slot 46 has a first guiding segment 462 extending in a width direction of the slat 30 and having one end thereof forming an opening 466 at the first edge 43, and a second guiding segment 464 extending in a length direction of the slat 30 and having two ends thereof connected with the first guiding segment 462 and the perforation 45, respectively. The recess 47 is recessed inwardly from the first edge 43 and located on the opposite side of the perforation 45 from the slot 46.

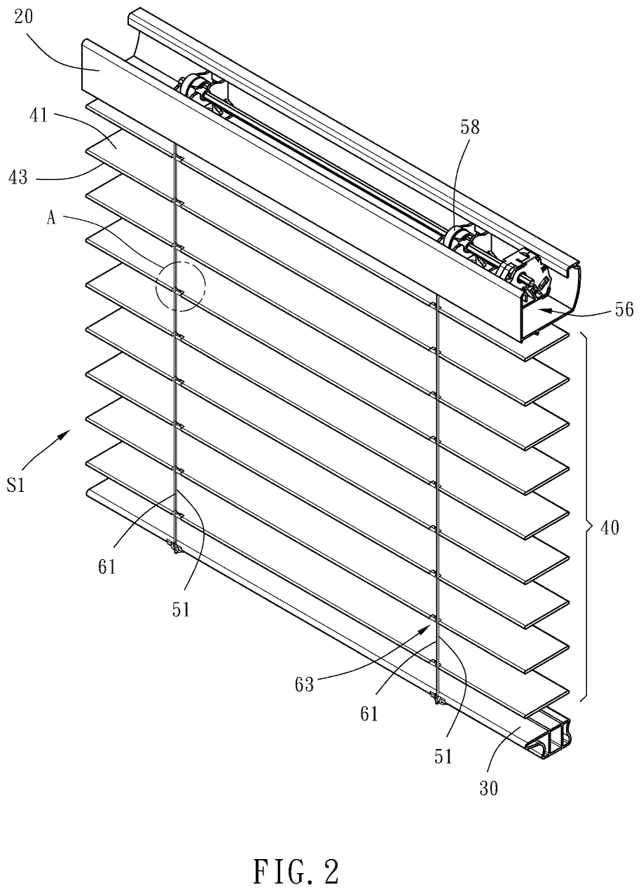

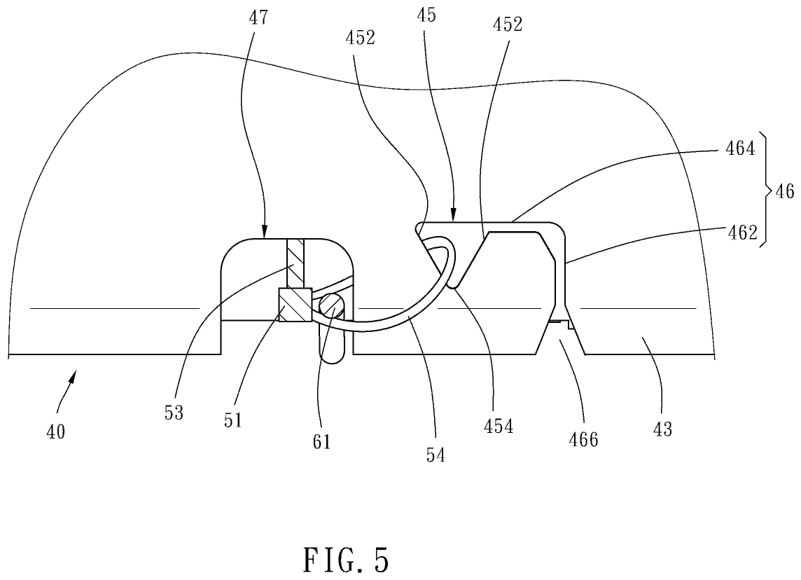

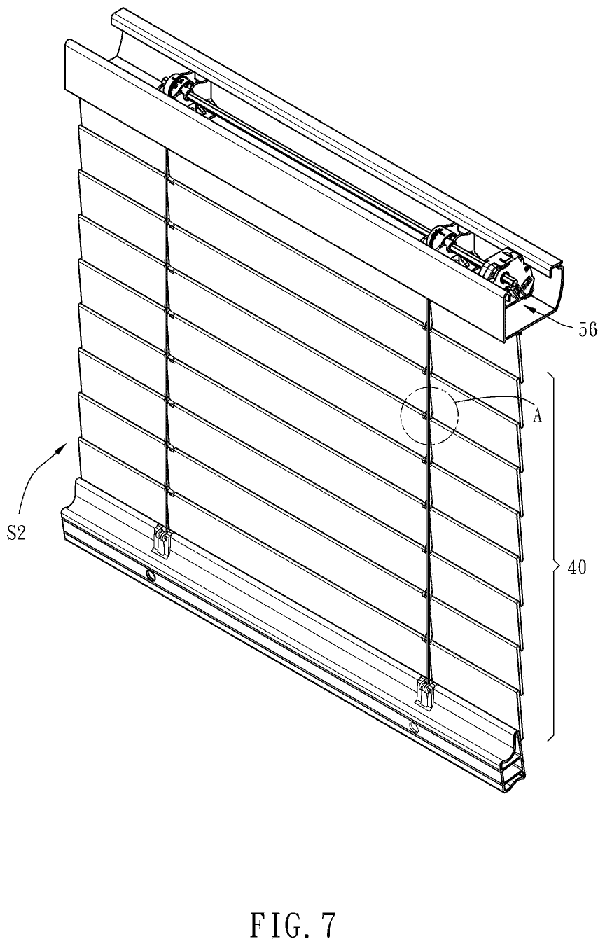

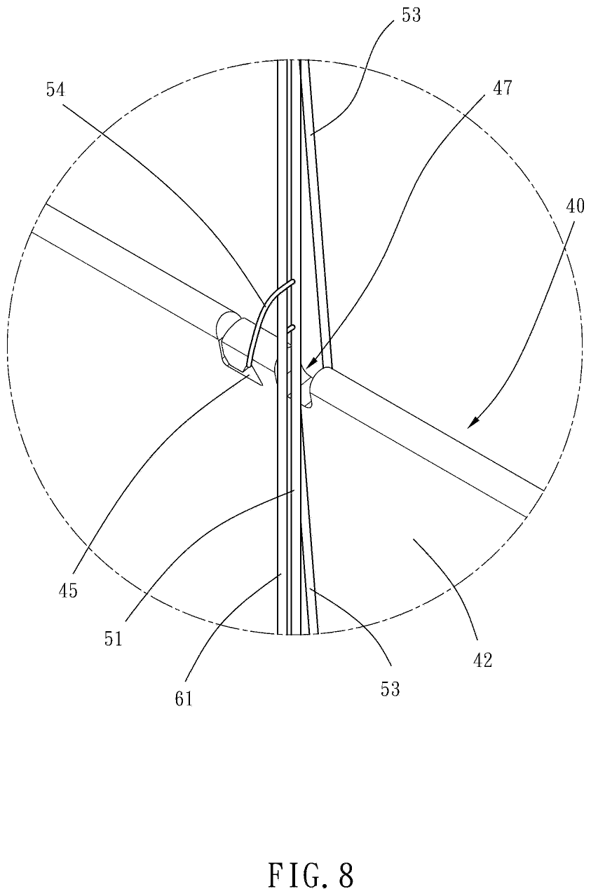

The two ladder cords 50 are provided between the headrail 20 and the bottom rail 30. As shown in FIGS. 3, 5, and 6, the two ladder cords 50 each have a first warp 51, a second warp 52, a plurality of wefts 53, a plurality of first loops 54, and a plurality of second loops 55. The first and second warps are parallel to each other and adjacent to the first and second edges 43, 44 of the slats 40, respectively. Further, the top ends of the first and second warps 51, 52 extend into the headrail 20 to be connected with a tape roll 58 disposed in the headrail 20 (as shown in FIGS. 1 and 2). The wefts 53 are connected between the first and second warps 41, 42 in an equidistant manner and support the bottom surfaces 42 of the slats 40. The first loops 54 are connected with the first warp 51 in an equidistant manner, and inserted into the first guiding sections 462 of the slots 46 through the openings 466, and then penetrated into the perforations 45 of the slats 40 from the second guiding sections 464 of the slots 46. Furthermore, the first loops 54 each have a first end portion 542 located above the top surface 41 of the slat 40 and provided with one end thereof connected with first warp 51, a second end portion 544 located below the bottom surface 42 of the slat 40 and provided with one end thereof connected with first warp 51, and a penetration segment 546 connected with the first and second end portions 542, 544 and penetrated in the perforation 45. A junction of the first end portion 542 and the first warp 51 is spaced from a junction of the second end portion 544 and the first warp 51. The second loops 55 are connected with the second warp 52 in an equidistant manner, and further, a junction of the top end 552 of the second loops 55 and the second warp 52 is spaced from a junction of the bottom end 554 of the second loop 55 and the second warp 52. In this way, the ladder cords 50 can be controlled by an adjuster 56 to drive the slats 40 to operate between a horizontal state S1 (as shown in FIG. 1) and a tilted state S2 (as shown in FIG. 7). When the slats 40 are in the horizontal state S1, the first warps 51 are positioned in the recesses 47 of the slats 40 (as shown in FIGS. 3 and 5). When the slats 40 are in the tilted state S2, the first warps 51 are located outside the recesses 47 of the slats 40 (as shown in FIG. 8).

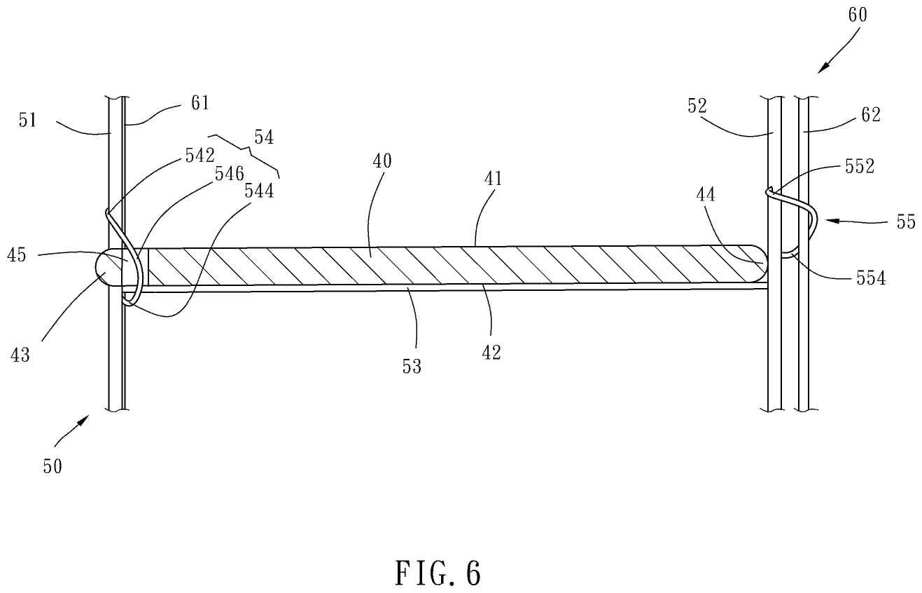

The lifting unit 60 includes two first pull cords 61 and two second pull cords 62. As shown in FIGS. 1 and 2, the first and second pull cords 61, 62 extend from the headrail 20 to the bottom rail 30. The top ends of the first and second pull cords 61, 62 are inserted into the headrail 62 and connected with a cord winder (not shown) disposed in the headrail 20, and the bottom ends of the first and second pull cords 61, 62 are connected with the bottom rail 30, so that the first and second pull cords 61, 62 can be controlled by the aforesaid cord winder to fold the slats 40 through the bottom rail 30. In addition, as shown in FIGS. 5 and 6, the first pull cords 61 pass through the first loops 54, and the second pull cords 62 pass through the second loops 55. When the slats 40 are in the horizontal state S1, the first pull cords 61 are positioned in the recesses 47 of the slats 40 (as shown in FIGS. 3 and 5). When the slats 40 are in the tilted state S2, the first pull cords 61 are located outside the recesses 47 of the slats 40 (as shown in FIGS. 8).

It can be seen from the above that the that the venetian blind 10 of the present invention uses the first loops 54 to be inserted into the perforations 45, so that the slats 40 are prevented from excessive transverse displacement, and further, when the slats 40 are in the tilted state S2, the first loops 54 are moved along the guiding surfaces 452 to the positioning portions 454. Since the first pull cord 61 has tension, when the first pull cord 61 is positioned in the recess 47, the slats 40 cannot be moved left and right, and at the same time, the first loop 54 is used to prevent the first pull cord 61 from escaping from the recess 47 when the slats 40 are unfolded. This allows the slats 40 to achieve an automatic alignment effect. On the other side, the venetian blind 10 of the present invention uses the mutual restraint between the first loop 54 and the first pull cord 61 to allow the first warp 51 and the first pull cord 61 to be positioned in the recess 47 at the same time when the slats 40 are unfolded. This allows the first warp 51 and the first pull cord 61 to be as close as possible, thereby visually presenting an integrated effect and achieving a simple overall appearance.

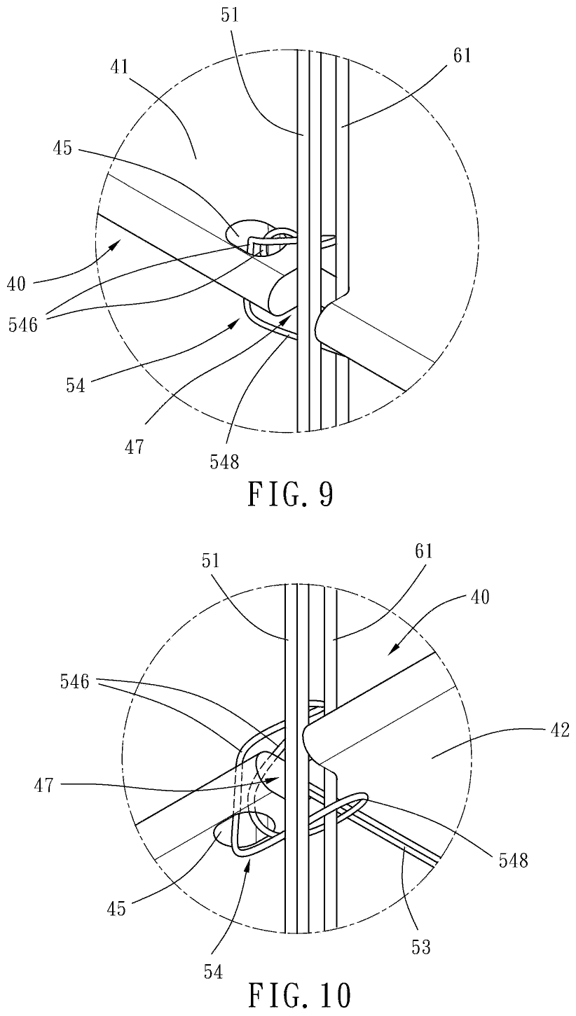

What needs to be supplemented here is that the way in which the first loop 54 is inserted into the perforation 45 may be varied. As shown in FIGS. 9 and 10, in the second embodiment, the first loops 54 each have two penetration segments 546 and a loop portion 548. The penetration segments 546 are penetrated in the perforation 45 and each have one end thereof connected with the first warp 51. Junctions of the penetration segments 546 and the first warp 51 are located above the weft 53 and spaced from each other. The loop portion 548 is connected with the other ends of the penetration segments 546 and located below the weft 53 and penetrated by the first pull cord 61. This also allows the first loop 54 and the first pull cord 61 to restrain each other, so that the first warp 51 and the first pull cord 61 are positioned in the recess 47 at the same time when the slats 40 are unfolded, thereby achieving the same effect as the aforesaid first embodiment.

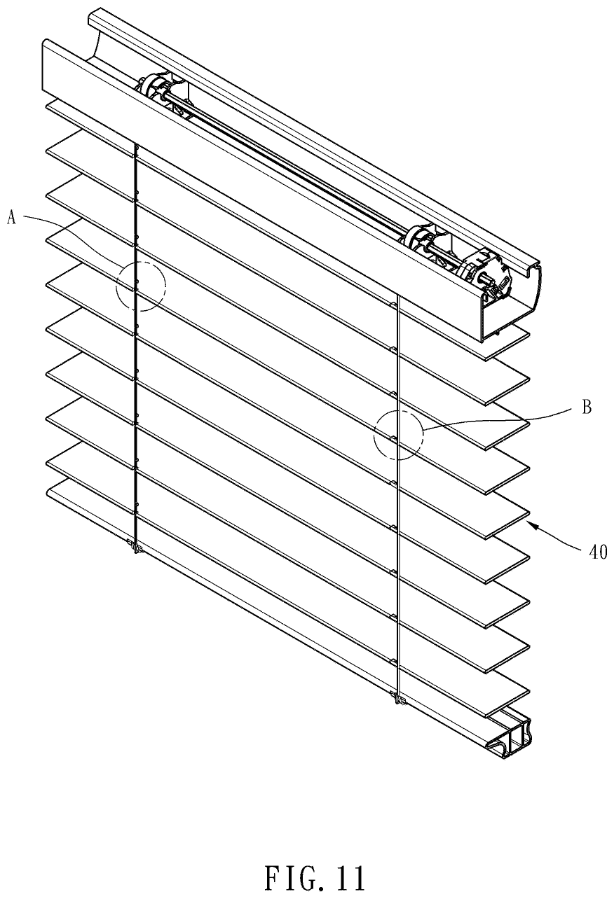

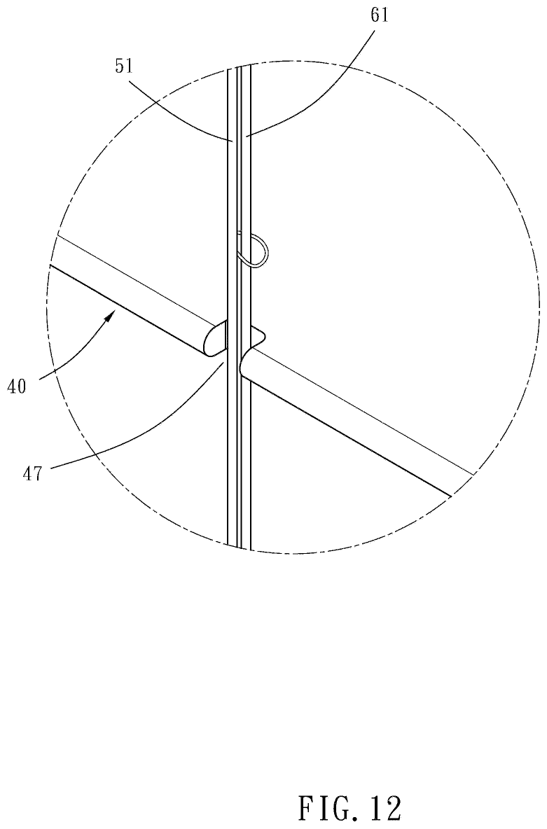

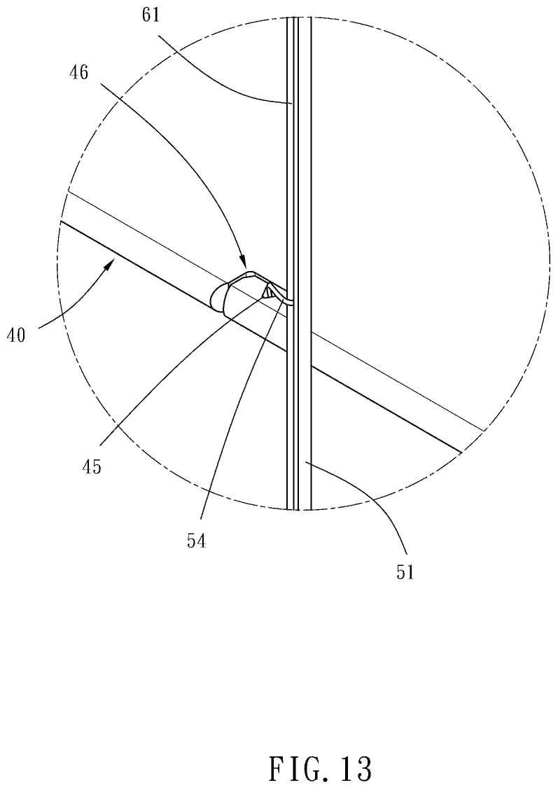

On the other side, the perforation 45, the slot 46 and the recess 47 are not limited to be set at both ends of the slat 40 at the same time, but can also be set at one end of the slat 40 respectively according to actual needs. As shown in FIGS. 11 to 13, in the third embodiment of the present invention, the perforation 45, the slot 46, and the recess 47 are provided at the same edge of the slat 40 (not limited to the first edge 43 or the second edge 44). The recess 47 is provided at one end of the slat 40, and the perforation 45 and the slot 46 are provided at the other end of the slat 40. As for the ladder cords 50, they only need to be provided with the first loops 54 on one of the first warps 51. In this way, through the restriction of the single recess 47, the slat 40 can also be prevented from transverse displacement, thus achieving the automatic alignment effect.

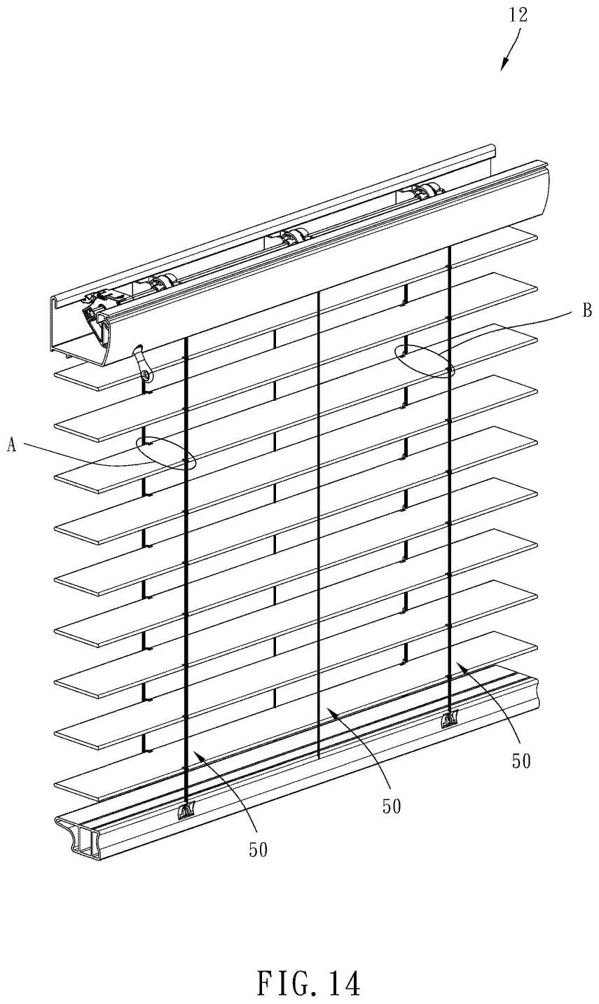

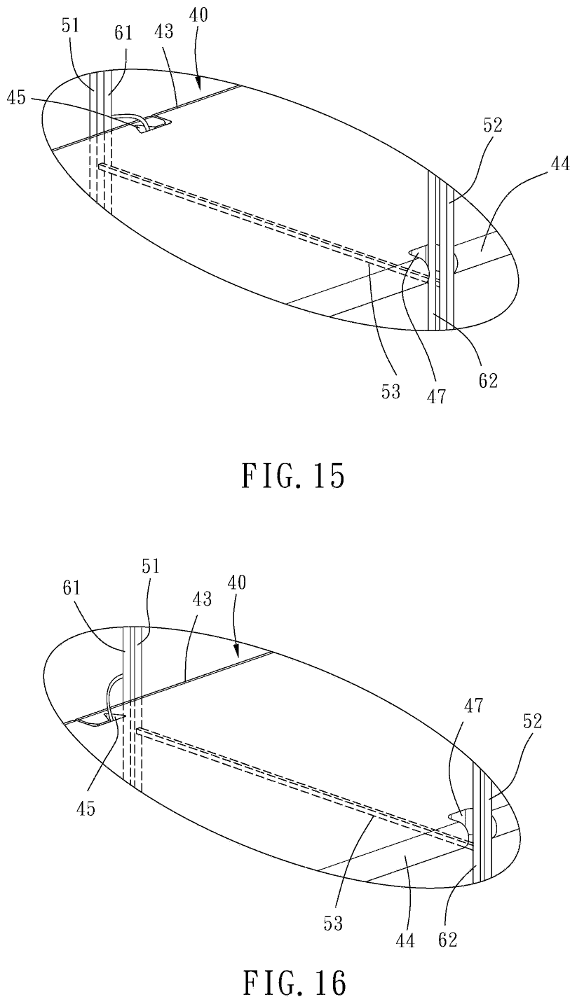

As shown in FIG. 14, the venetian blind 12 of the fourth embodiment of the present invention have three ladder cords 50. In this embodiment, as shown in FIGS. 15 and 16, the perforation 45 is provided at the first edge 43 of the slat 40, and the recess 47 is provided at the second edge 44 of the slat 40 and accommodates the second pull cord 62 and the second warp 52. The perforation 45 and the recess 47 can, but not limited to, be opposite to each other. In addition, in this embodiment, the left first pull cord 61 and the left second pull cord 62 are located on the left and right sides of the weft 53 (as shown in FIG. 15), and the right first pull cord 61 and the right second pull cord 62 are located on the same side of the weft 53 (not limited to the left or right side) (as shown in FIG. 16). Such a structural configuration also prevents the first and second pull cords 61, 62 from moving, thus effectively limiting the transverse displacement of the slats 40.

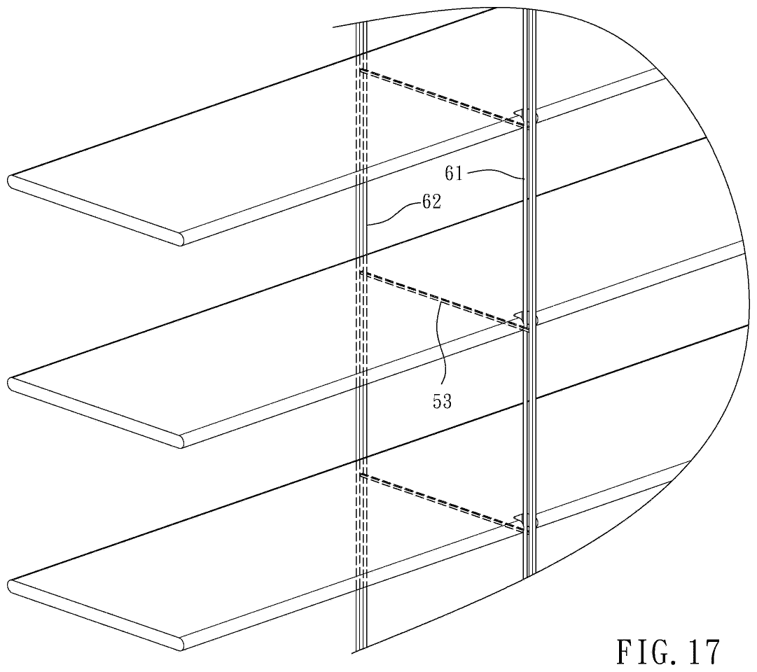

It is worth mentioning that the first loop 54 can also be omitted according to actual needs. In this case, as shown in FIG. 17, the first pull cord 61 is wound around the wefts 53 from top to bottom in a left-right manner, so that the first pull cord 61 is restricted by the wefts 53 without moving; similarly, the second loop 55 can also be omitted according to actual needs. In the case where the second loop 55 is not provided, the second pull cord 62 is also wound around the wefts 53 from top to bottom in a left-right manner, so that the second pull cord 62 is restricted by the wefts 53 without moving.

What is claimed is:

1. A venetian blind comprising:
a headrail;
a bottom rail located below the headrail;
a plurality of slats provided between the headrail and the bottom rail, each of the slats having a top surface, a bottom surface, a first edge connected with the top and bottom surfaces, a second edge connected with the top and bottom surfaces and opposite to the first edge, a perforation passing through the top and bottom surfaces, and a recess provided at one of the first and second edges;
two ladder cords provided between the headrail and the bottom rail, each of the ladder cords having a first warp adjacent to the first edges of the slats, a second warp adjacent to the second edges of the slats, a plurality of wefts connected with the first and second warps and supporting the bottom surfaces of the slats, and a plurality of first loops connected with the first warp and penetrated in the perforations of the slats; and
a lifting unit having a first pull cord adjacent to the first wrap and a second pull cord adjacent to the second wrap;
wherein at least one of the first pull cord, the second pull cord, the first warp, and the second warp is positioned in the recesses of the slats.

2. The venetian blind as claimed in claim 1, wherein the recess is provided at the first edge; when the slats are in a horizontal state, the first pull cord is positioned in the recesses of the slats.

3. The venetian blind as claimed in claim 1, wherein the recess is provided at the first edge; when the slats are in a horizontal state, the first warp is positioned in the recesses of the slats.

4. The venetian blind as claimed in claim 1, wherein the recess is provided at the first edge; when the slats are in a horizontal state, the first pull cord and the first warp are positioned in the recesses of the slats.

5. The venetian blind as claimed in claim 1, wherein the recess and the perforation are provided at the first edge; the slats each have a slot provide with one end thereof forming an opening at the first edge and the other end thereof communicating with the perforation; the first loop is inserted in the slot through the opening and penetrated in the perforation along the slot; the recess and the slot are located at two opposite sides of the perforation.

6. The venetian blind as claimed in claim 1, wherein the recess is provided at the second edge; when the slats are in a horizontal state, the second pull cord is positioned in the recesses of the slats.

7. The venetian blind as claimed in claim 1, wherein the recess is provided at the second edge; when the slats are in a horizontal state, the second warp is positioned in the recesses of the slats.

8. The venetian blind as claimed in claim 1, wherein the recess is provided at the second edge; when the slats are in a horizontal state, the second pull cord and the second warp are positioned in the recesses of the slats.

9. The venetian blind as claimed in claim 1, wherein the perforation is provided at the first edge and the recess is provided at the second edge; the slats each have a slot provide with one end thereof forming an opening at the first edge and the other end thereof communicating with the perforation; the first loop is inserted in the slot through the opening and penetrated in the perforation along the slot.

10. The venetian blind as claimed in claim 1, wherein the first pull cord passes through the first loops.

11. The venetian blind as claimed in claim 10, wherein the first loops each have a first end portion provided with one end thereof connected with first warp, a second end portion provided with one end thereof connected with first warp, and a penetration segment connected between the first and second end portions and penetrated in the perforation; a junction of the first end portion and the first warp is spaced from a junction of the second end portion and the first warp.

12. The venetian blind as claimed in claim 10, wherein the first loops each have two penetration segments penetrated in the perforation and each provided with one end thereof connected with the first warp, and a loop portion connected with the other ends of the penetration segments and penetrated by the first pull cord; a junction of one of the penetration segments and the first warp is spaced from a junction of the other of the penetration segments and the first warp.

13. The venetian blind as claimed in claim 1, wherein the first and second pull cords are located at left and right sides of the wefts.

14. The venetian blind as claimed in claim 1, wherein at least one of the first and second pull cords is wound around the wefts in a left-right manner.

15. The venetian blind as claimed in claim 1, wherein the ladder cords each further have a plurality of second loops connected with the second warp; the second pull cord passes through the second loops.
